(19) United States
(12) Patent Application Publication
(10) Pub. No.: US 2002/0127259 A1
(43) Pub. Date: Sep. 12, 2002

(54) Rumen by-pass delivery system

(76) Inventor: Frand T. Orthoefer, Germantown, TN (US)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(21) Appl. No.: 10/024,504

(22) Filed: Dec. 21, 2001

Related U.S. Application Data
(60) Provisional application No. 60/317,952, filed on Sep. 10, 2001.
(60) Provisional application No. 60/073,990, filed on Feb. 6, 1998.

(51) Int. Cl. A01N 25/08; A23K 1/165; A23K 1/18

(52) U.S. Cl. 424/409; 424/438; 424/442

(57) ABSTRACT

The present invention relates to a composition for the delivery of active agents that are protected from environmental oxidation and are resistant to ruminal fermentation degradation but not intestinal digestion and adsorption. The composition may contain biologically active ingredients such as for example, vitamins, minerals, proteins, amino acids, fatty acids, nutritional supplements, and pharmaceuticals together with natural and/or synthetic lecithin phospholipids.

### BACKGROUND OF THE INVENTION

(i) Field of the Invention

The present invention relates to a composition for the delivery of active agents that are protected from environmental oxidation. The present invention further provides improvements in the fields of nutrient preparation, feed and veterinary drugs.

(ii) Description of the Related Art

Rumen fermentation can reduce the nutritive value of carbohydrates and proteins while destroying unsaturated lipids by hydrogenation. Unprotected biologically active agents that are delivered orally to ruminants are degraded substantially by bacteria which contain fermentation enzymes.

In ruminant animals, such as cattle or sheep, the direct oral administration of biologically active substances, such as amino acids and vitamins, causes most of the substances to be decomposed in the rumen; thus they are not effectively utilized. Accordingly, it is important to pass the biologically active substances through the rumen without decomposition to allow the biologically active substances to be effectively digested and absorbed in the subsequent digestive tract.

The rumen is the largest of the four digestive chambers of ruminants and is that portion of the stomach where the metabolic breakdown of ingested fodder takes place. Microorganisms which are present in the rumen pre-digest or degrade the diet by fermentation over a period of time ranging from about 6 to 30 hours or longer. Much ingested protein material is broken down in the rumen to soluble peptides and amino acids that are used as nutrients by the microorganisms. The microbial population in the rumen includes bacteria, protozoa, and fungi. The microbes that digest fiber thrive at a pH of 6.2-6.8. Those that digest starch prefer a pH of 5.2-6.0. Generally, the optimum range in digestive pH is slightly acidic at about 5.8- 6.4 for synthesis of microbial protein and B-complex vitamins.

When the rumen contents are passed into the subsequent digestive chambers, the microorganisms flow out as well. Once the contents dump into the abomasum and intestine, the microbial mass is digested, providing protein and amino acids to the ruminant. The ordinary nutritional balance of the ruminant is mainly a function of the microbial composition and colony size. Many nutrients and medicaments designed for use with ruminants, must be protected against microbial action and the effects of pH, so that the active agent can remain bioavailable at the absorption site. Milk, meat, and wool production can be increased if essential amino acids are not destroyed by the microorganisms of the rumen, but are absorbed in the lower gastrointestinal tract. For example, the bacteria in the rumen of a cow easily degrade or metabolize free crystalline amino acids, like lysine and methionine into byproducts. Thus, when the biomass reaches the intestine there are no amino acids remaining.

There are numerous methodologies that are designed to protect amino acids from ruminal degradation including: heat and chemical treatment, encapsulation and coating, use of amino acid analogs, and polymeric compounds of amino acids.

U.S. Pat. No. 3,959,493 to Baalsrud et al. describes a rumen bypass system that uses aliphatic fatty acids having at least 14 carbon atoms. Such fatty acids (FAs) are applied as a coating to the nutrient because the said FAs are resistant to rumen degradation. The active agents then are delivered to the abomasum and/or intestine where the FAs are reduced in that post-ruminal environment. U.S. Pat. No. 5,093,128 to Draguesku et al, describes a beadlet nutrient coating which includes fats and calcium based products. Coated ruminant nutrients have the disadvantage of cracking or abrading either in handling or in being masticated by the animal.

U.S. Pat. No. 4,808,412 to Smith et al. describes a rumen stable composition containing a active agent molecularly dissolved with a basic polymer. The active agent is delivered post-ruminally since the polymer is resistant to a pH of greater than about 5, but is soluble or swellable at a pH of less than about 3.5. In this type of dispersion, some of the active agent at and near the surface of the composition will be destroyed by the action of ruminal microbes since cracks or channels can occur on the surface, and reduce the effectiveness of the protection.

U.S. Pat. No. 6,242,013 to Luhman et al., describes a ruminally-protected high oleic material produced by roasting oilseeds at high temperatures to protect the fatty acids fed to ruminants. However, the roasting procedures require costly energy consumption.

U.S. Pat. No. 4,642,317 to Palmquist et al., describes a process for supplying fatty acids to ruminants in the form of their calcium salts. However, the sole use of fatty acid salts as feed additives creates a distinctly disagreeable odor from the oxidation of the organic volatiles in the feed causing a reduction in feed intake and milk yield. U.S. Pat. No. 6,229,031 to Strohmaier et al., describes a method for manufacturing feed supplements by converting lipids that are byproducts of the food and meat processing industries, to their calcium salt form. In addition to the odor, it is illegal to feed byproducts of food and meat processing to ruminants because they are implicated as being a possible source of BSE (bovine spongiform encephalopathy).

U.S. Pat. No. 5,714,185 to Mahadevan describes a scheme for treating protein substances with zein/formaldehyde to render the ingredients protected. However, formaldehyde results in the destruction and reduced bioavailability of most essential amino acids. (Broderick G A et al., Control of rate and extent of protein degradation, p 541, 1991; In Physiological Aspects of Digestion and Metabolism in Ruminants, Tsuda T, Saski Y, Kawashina R, eds. Academic Press, London) Furthermore, the level of formaldehyde sometimes used is too high creating health concerns associated with its carcinogenicity. Further the scheme has not been approved by the FDA for animal feed applications.

Fish meal provides a high quality protein to the ruminant. However, a major disadvantage to the use of fish meal is its potential dioxin content and its high cost.

Ruminants also have special requirements to increase milk production and weight gain. U.S. Pat. No. 5,496,571 to Blagdon et al., describes a means of enhancing the production of milk in a ruminant by orally administering encapsulated choline chloride. WO 96/08168 to Chandler describes a ruminant feedstuff to improve milk yields in dairy cattle. The feedstuff is composed of a rumen-protected choline compound having a protective coating containing at least one fatty acid or fatty acid soap. U.S. Pat. No. 5,807,594 to King et al., describes a method of improving weight gain and feed efficiency in a ruminant by encapsulating a choline chloride composition in a rumen-protected carrier. Suitable encapsulating or coating materials for use in this invention include among others: hydrogenated oils, mono- and di-glycerides, waxes, and seed fats. U.S. Pat. No. 6,022,566 to Miller describes the addition of fat to a feed ration and then adding rumen protected encapsulated choline chloride in an amount proportional to the added fat. However, such coatings and encapsulations of choline chloride are subject to abrasion, cracking and other abuses during transport and handling thereby rendering the coatings permeable to rumen fluids and microorganisms that destroy the choline.

Also, it has been proposed to coat ruminant animal feed additives containing biologically active substances with protective substances, such as fatty acids, hardened animal oils and hardened vegetable oils. However, particles coated with these fats and oils are stable, not only in the rumen, but also in the abomasum and subsequent digestive tract making the biologically active substances difficult to be released in the abomasum and subsequent digestive tract.

For this reason, methods were proposed that added substances propelling the release of the biologically active substances in the abomasum and its subsequent digestive tract that contained such protective substances. In these methods, the biologically active substances are dispersed in the coating materials or contain a core which is coated with a protective material as described in U.S. Pat. Nos. 5,300,297 to Ueda et al., 5,405,628 to Ueda et al., 5,227,166 to Ueda et al., and 5,676,966 to Kitamura et al.

Phospholipids, also known commercially as lecithin, are an important component of the present invention. The term “phospholipid” as used herein does not refer only to a single phospholipid, such as phosphatidylcholine, but rather to any combination of phospholipids, either powdered, granular, liquid, bleached, enriched, unbleached, modified or synthetic.

Lecithin has been used as an ingredient in formulations that incorporate nutritional supplements, medications, and pharmaceutical drugs for animals and humans. In particular, lecithin phospholipids are used to create a liquid crystal solid composition for oral delivery of medicaments as described in U.S. Pat. No. 6,312,703.

Therefore, there is a need to formulate products which will allow the amino acids to be stable in the rumen, but capable of absorption when they pass from the rumen into the intestine. A need also exists for a nutrient-containing rumen protected composition which in addition to the advantages aforementioned, contains the highly bioavailable lecithin choline; a B complex vitamin; a high percentage of linoleic acid; and/or other an essential fatty acids and vitamins. There is also a need for a nutrient-containing product that is protected in the rumen, bioavailable in the intestine, and not subject to cracking, punctures, abrasion, or surface scratches wherein the active agents of the nutrient-containing product could be vulnerable to the ruminal fluids and/or microorganisms resulting in degradation or metabolism. In addition, it there need for a nutrient-containing rumen protected composition that is created with a simple, low maintenance and inexpensive manufacturing process. There is also a need for a nutrient-containing rumen protected composition that has an acceptable taste and odor, and that does not contain animal by-product fats and proteins and is legal. The need exists to provide non-toxin containing nutritional supplements and amino acids in a rumen protected form at a low cost and to improve feed intake, feed efficiency, daily gain, and carcass grade or ruminants. A need exists to make choline chloride more bioavailable.

The aforementioned and other advantages are addressed in the present invention. Other advantages will be readily apparent from further discussion and to those skilled in the art.

### SUMMARY AND OBJECTS OF THE INVENTION

One advantage of the present invention relates to feed additives for ruminants. The feed additive composition may contain one or more biologically active agents or ingredients which are protected from oxidation and stable in the rumen, but subject to intestinal digestion and absorption.

Another advantage of the present invention is to deliver active agents or ingredients to the post-ruminal digestive tract so that efficient absorption can take place. The present invention relates to a delivery composition that efficiently carries the oral nutrients and drugs to the absorption site. One advantage of the present invention is that it is more cost effective than other rumen protected systems that rely on coating or encapsulating the active ingredients.

The present invention has the further advantage of being resistant to ruminal fermentation degradation while allowing for intestinal digestion and absorption. The composition may further contain biologically active ingredients such as, vitamins, minerals, amino acids, and pharmaceuticals together with lecithin phospholipids. These constituents may be structured into a solid (liquid crystal) phospholipid matrix consisting of modified forms of animal and/or plant lecithins. The active ingredients are blended with the phospholipids and subsequently cosolubilized.

The present invention is directed to a composition comprised of an amount of lecithin phospholipid equal to about 30% by weight of the total composition and can contain an amount equal to as much as about 95% by weight of the total composition. The active agents can be present in the said composition in an amount between about 5% and 70% by weight of the total composition. The formation of the present invention is initiated by selecting a modified or unmodified lecithin containing natural or synthetic phospholipids to create a non-hydratable or, less hydratable phospholipid composition that will be unaffected by microbial action in the rumen. The composition of the present invention may include a combination of a metal salt with the phosphate of lecithin. Multivalent metals such as for example calcium, magnesium, and aluminum may be used to modify the phospholipids.

Regardless of the lecithin used, the formation of the composition of the present invention is initiated by low shear mixing an amount of lecithin equal to between about 30% and 95% by weight of the total composition, together with between about 5% and 70% of the active components to be rumen protected. The aforementioned combination is then compressed under an amount of pressure equal to at least about 100 pounds per square inch (psi). Lecithin phospholipids that are suitable for use in the present invention may be from a wide variety of plant or animal sources, bleached, unbleached, synthetic, natural, enriched, fractionated, powdered, granular, liquid, coated, uncoated, out of specification, or unsuitable for human consumption lecithins.

The nutrient containing rumen protected active agents of the present invention may include such active agents or active agents as nutrients, amino acids, hormones, minerals, macro-minerals, trace minerals, antibiotics, vitamins, amino alcohols, polyols, peptides, phytochemicals, fats, rumen inert fats, fatty acid soaps, fatty acid salts, enzymes, emulsifiers, hormones, pharmaceuticals, and other animal medicaments.

In accordance with one aspect of the present invention, it is desirable that the active agent, such as for example, amino acids be bioavailable only in the lower gut, and remain stable and unmetabolized in the rumen.

Another advantage of the present invention is a composition comprising choline chloride which results in greater bioavailability of the choline chloride.

The present invention advantages also allow for amino acids, particularly lysine, methionine and histidine to be delivered to ruminants.

Another aspect of the present invention is composition comprising a modified lecithin having the formula C₈H₁₇O₅NRR′, wherein R and R′ are fatty acids having the formula CH₃(CH₂)ₙCOO, wherein n is between 4 and 22; and a active agent wherein said lecithin is present in an amount effective to protect said active agent from environmental oxidation.

The composition of the present invention may also include an active agent intended for consumption by an animal that subjects the agent to ruminal fermentation degradation and the lecithin is present in an amount effective to protect the active agent from ruminal fermentation degradation while allowing for intestinal digestion and absorption of the active agent.

The composition of the present invention may also include lecithin phospholipids which are non-hydratable allowing the lecithin phospholipids to pass more or less intact through the rumen into the intestine. The composition of the present invention may further comprise phosphatidylcholine in the lecithin composition in an amount effective to disintegrate the composition in the post-ruminal digestive tract.

The composition of the present invention may contain an amount of modified lecithin between about 30% and 95% by weight of the total composition. Further, the composition of the present invention may contain an amount of active agent between about 5% and 70% by weight of the total composition.

The present invention also provides a method for providing an active agent to a ruminant comprising administering to the ruminant the composition comprising a modified lecithin having the formula C₈H₁₇O₅NRR′, wherein R and R′ are fatty acids having the formula CH₃(CH₂)ₙCOO, wherein n is between 4 and 22; and an active agent wherein said lecithin is present in an amount effective to protect the active agent from environmental oxidation.

The composition of the present invention includes for example the inclusion of active agents such as essential amino acids, vitamins, minerals, antibiotics, amino alcohols, polyols, peptides, phytochemicals, fats, rumen inert fats, fatty acid soaps, fatty acid salts, enzymes, emulsifiers, hormones, pharmaceuticals, disintegrants and other animal medicaments. The essential amino acid include lysine, methionine, histidine or combinations thereof. The vitamins include B-complexes, A, D, E, K, C, and combinations thereof. The minerals include cobalt, copper, iodine, iron, manganese, selenium, zinc or combinations thereof. The antibiotics include teramycin, tetracycline, bacitracin or combinations thereof. The amino alcohols include choline, ethanolamine, serine, or combinations thereof. The polyols include sorbitol, mannitol, maltitol or combinations thereof. The emulsifiers include monoglycerides, lactylates, diacetyltartaric acid esters, sugars, salts or combinations thereof. The phytochemicals include sterols, stanols, carotenoids, flavonoids or combinations thereof. The fatty acid soaps include calcium, magnesium, iron, zinc, chromium, manganese, copper fatty acid soaps or combinations thereof. The rumen inert fats include calcium salts of long chain fatty acids and Megalac, Super-Lac, Advance EB 100, EnerGII, Lipicafat, or combinations thereof.

Another aspect of the present invention includes a composition comprising a modified lecithin having the formula C₈H₁₇O₅NRR′, wherein R and R′ are fatty acids having the formula CH₃(CH₂)ₙCOO, wherein n is between 4 and 22; and an active agent wherein the lecithin is present in an amount effective to protect the active agent from environmental oxidation wherein the lecithin phospholipid is complexed with a multivalent metal salt in a ratio of between 100:1 and 400:1.

The present invention also provides a method for making a composition which is rumen stable for providing active agents to ruminants, comprising: (i) selecting an amount of lecithin phospholipids or lecithin phospholipids complexed with a multivalent metal salt in a ratio of between 100:1 and 400: 1, wherein the complexed amount is equal to between about 30% and about 95% by weight of the total composition, and (ii) selecting an amount of active agents in an amount equal to between about 5% and about 70% by weight of the total composition, and, (iii) mixing the selected amounts of lecithin or complexed lecithin phospholipids and active agents in a mixing device, and (iv) placing an amount of the mixed lecithin phospholipids and active agents in a means for compressing the mixture, and (v) compressing and/or extruding the mixture in the compression means for at least 5 seconds at a pressure of at least 100 psig, whereby the compression means forms a matrix having a density range of between about 0.95 and 1.2.

The method of the present invention includes lecithin phospholipid that is complexed with a multivalent metal salt selected from unbleached, synthetic or coated lecithin. The method of the present invention also includes lecithin phospholipid that is complexed with a multivalent metal salt which is enriched in phosphatidylcholine in excess of 23%, or phosphatidylethanolamine in excess of 21%, or phosphatidylinositol in excess of 19%.The method of the present invention also includes active agents are selected from the group consisting of essential amino acids, vitamins, minerals, antibiotics, amino alcohols, polyols, peptides, phytochemicals, fats, rumen inert fats, fatty acid soaps, fatty acid salts, enzymes, emulsifiers, hormones, pharmaceuticals, disintegrants and other animal medicaments.

The method of the present invention also includes additives to the complexed lecithin phospholipid and active agents, in the compression means to alter the bioavailability of the active agents. The method of the present invention may contain additives including disintegrants, calcium stearoyl-2-lactylate, sodium stearoyl lactylate, ethoxylated monoglyceride, polysorbates, dry monoglycerides, starches and sugars. The additive may also include for example modified lecithin phospholipids, particularly hydroxylated lecithin, and enzyme modified lecithins. The method of the present invention may also be formed into a size and shape suitable for ingestion by ruminant animals.

Other advantages and embodiments of the present composition and methods will apparent from the disclosure below and by those skilled in the art.

### DETAILED DESCRIPTION OF PREFERRED EMBODIMENTS

The present invention relates to a composition for the delivery of active agents that are protected from environmental oxidation and are resistant to ruminal fermentation degradation but not intestinal digestion and absorption. The composition may contain biologically active ingredients such as for example, vitamins, minerals, proteins, amino acids, fatty acids, nutritional supplements, and pharmaceuticals together with natural and/or synthetic lecithin phospholipids. These constituents are structured into a solid [liquid crystal] phospholipid CL) matrix consisting of modified or unmodified forms of animal and/or plant lecithins including natural and synthetic phospholipid products, fats, and calcium fat. To form the composition, active ingredients are blended with the lecithin and are subsequently cosolubilized, or shear mixed, or intimately mixed, by pressure melting of the lecithin phospholipids with the active agents. The composition thus formed is cut easily into any acceptable size and shape.

The present invention, in which the active agents are incorporated into the solid phospholipid matrix, has the advantage that the actives are protected and/or inaccessible to the fermentation agents in rumen. The said actives are also protected by lecithin, an antioxidant that is well known as a stabilizing ingredient. The present invention also has the advantage that the phospholipids are classified by the FDA and EPA as GRAS, and structurally contain vitamins essential to health. The present invention is very cost effective in terms of the carrier phospholipids, equipment, and production time, since there is no need for a sophisticated process to microencapsulate or polymer coat the composition.

Compressed lecithin phospholipids become hydrated and disintegrate over a relatively long period of time. The rate of disintegration can be altered by changing the chemical composition of the lecithin. For example, modifying phospholipids using enzymes has been shown to increase disintegration rates, while use of non-hydratable phospholipid fractions decreases the rate of dissolution. The relative rate of phospholipid hydration was given by Seghers in 1990 as follows: Phosphatidylcholine (PC) 100%; phosphatidylinositol (PI) 44%; P-ethanolamine (PE) 16%; phosphatidic acid (PA) 8.5%. Lecithin phospholipids manufactured by the use of multivalent metals such as Ca, Mg, or Al tend to decrease the rate of product dissolution. For example, calcium salts of PI, PE, and PA have a very low hydration rate of ˜1%. (Brockisch, M, Fats and Oils Handbook, AOCS, p. 429, 1993). The phospholipids used in the present invention can be selected to include only individual phosphatides, or can include combinations thereof, by varying the amounts of each phosphatide in the composition. Lecithins that do not meet the phospholipid specification for human consumption, or lecithins which remain in the sediment after ethanol extraction of phosphatidylcholine from commercial lecithin may also be used in the present invention. Such waste products contain higher amounts of the nonhydratable phospholipid fractions PE, PI. (Cevc G., et al, Phospholipids: Characterization, Metabolism, and Novel Biological Applications, AOCS. 1995, p353)

A preferred compressed lecithin for use according to the present invention is that disclosed in copending application Serial No. 09/245,289, the disclosure of which is hereby incorporated by reference. Additionally, provisional applications 60/317,952 and provisional application number not yet assigned filed on Dec. 12, 2001 are hereby incorporated by reference.

The non-hydratable characteristics of the lecithin phospholipids (LP) allows them to pass more or less intact through the rumen into the intestine. The presence of phosphatidylcholine (a hydratable PL) in the PL mix functions to disintegrate the composition in the post-ruminal digestive tract where absorption takes place.

The present invention is initiated by selecting an amount of multivalent modified lecithin (MML) between about 30% and 95% by weight of the total composition and an amount of active agents (AAs) between about 5% and 70% by weight of the total composition. The active agents can consist of for example, vitamins, minerals, lipid and water soluble nutrients, phytochemicals, amino acids, pharmaceuticals and other excipients or disintegrants.

These ingredients are then co-solubilized into a solid matrix by compression either in an extruder, or in a bench press, or in a three roll refiner, or in a dough mixer, or with chocolate mixing equipment as examples. Whatever device is used, the MML and AAs must be subjected to a sufficient amount of pressure (for example, 100 psi), for an amount of time ( for example, 5 seconds). The resulting chemical composition will consist of a matrix containing the MML, AAs and other desirable excipients. At this point the AAs can only be separated from the MML by chemical means, such as with the use of solvents.

The present invention, in which the AAs are incorporated into the solid MML matrix, has the advantage that the AAs are protected and/or inaccessible to the fermentation agents in rumen. The AAs are also protected by lecithin, an antioxidant and a stabilizing ingredient. Another advantage of the present invention is that the phospholipids are classified by the FDA and EPA as GRAS. Since there is no sophisticated process to microencapsulate or polymer coat the AAs, the present invention is very cost effective in terms of the carrier phospholipids, equipment, and production time.

The present invention relates to a composition (hereinafter called the matrix) made up of deoiled lecithin (DL), or multivalent modified lecithins (MML), or complexed phospholipids (CP), or compounded lecithins (CL), or synthetic lecithins (SL) together with active agents for use in delivery of nutrient preparations to ruminant animals, wherein the ruminal degradation of the active agents may be controlled. This invention also relates to the method of making the matrix composition.

The matrix compositions may be made with plant or animal lecithins, powdered, granular, or liquid, said lecithins having a phospholipid composition as an acetone insoluble index equal to or greater than 90%. The matrix also can be made with individual phosphatides, said phosphatides being phosphatidylcholine (PC), phosphatidylinositol (PI), phosphatidylethanolamine (PE), and phosphatidic acid (PA). The matrix also can be made with combinations thereof, by varying the amounts of each phosphatide in the composition. The formulas for the specific phospholipid components are as follows:

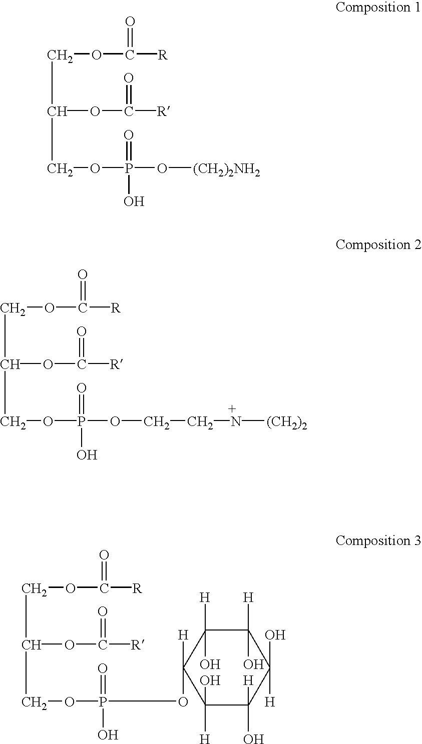

The terms R and R′ in the above disclosed phospholipid components are fatty acids having the formula CH₃(CH₂)ₙCOOH, with n equal to between 4 and 22. Additionally, lecithin has a general formula of C₈H₁₇O₅NRR′ where R and R′ are fatty acids having the formula CH₃(CH₂)ₙCOOH, with n equal to between 4 and 22. One skilled in the art will appreciate that other fatty acids containing other R groups, including those with cyclic structure and with and without heteroatoms, may also be used according to the present invention.

The present invention provides a composition for delivery of active agents that can effectively be digested and absorbed by ruminant animals and is safe and economical. Additionally, the present invention provides a method that protects a biologically active substance stably while allowing efficient digestion and absorption in digestive tract. For example, in the formulations of compositions 1-3, the solid [liquid crystal] phospholipids are not degraded by low pH fluids, but rather serve as a means to deliver nutrients in a protected matrix through the acidic environment of the animal or human stomach. After delivery to the aqueous small intestine, the matrix hydrates and releases its active ingredients. In other words, the aforementioned lecithin matrix protects against the acid material of the stomach, while the composition of the present invention protects against the aqueous digestible material of the rumen.

It is also known that dairy cattle can suffer from ketosis which is associated with large milk production and also affects newly lactating cows. Ketosis is associated with fat infiltration of the liver. Choline plays an key role in fat metabolism in the liver. It prevents abnormal accumulations of fat in the liver by converting the excess fat into lecithin or by increasing the utilization of the fatty acids in the liver. Rumsey's 1985 data (T. S. Rumsey, “Effect of Choline in All-concentrate Diets of Feedlot Steers and on Ruminal Acidosis”, Can. J. Anim. Sci. 65: 135-146, Mar. 1985). suggests that choline may affect lipid metabolism similar to that of humans by increasing the ability of the liver to synthesize and enable the transport of lipid to tissues. The lecithin of the present invention provides an amount of highly bioavailable choline equal to between about 1% and 12% by weight of the total composition allowing the choline to act as a hepatic protector against ketosis.

Sixty percent of the fatty acids in the lecithin of the present invention are linoleic acid, which is provided in an amount of between about 16% and 56% by weight of the total matrix composition. Linoleic acid is the precursor of conjugated linoleic acid (CLA) and an anticarcinogen. It is known that ruminal microbes help create CLA by secreting enzymes that contribute to the breakdown of food and the digestion of dietary linoleic acid. The CLA is absorbed through the rumen where it becomes a stable component of milk fat. Since CLA carries significant health benefits even at lower levels of consumption than other naturally occurring anti-carcinogens it is particularly adapted to incorporation to the composition of the present invention. CLA research also has shown that mice, rats, chickens, and rabbits fed diets that included CLA, ate less overall and showed an increase in body protein and a drop in body fat. (Haumann B F, Feb. 1996; 7(2): 152-159). Pork was found to be leaner by incorporating CLA into swine feed. (Wiegand B R et al, J Anim Sci 2001 Aug; 79(8): 2187-95 and Thiel-Cooper R L et al., J Anim Sci 2001 July; 79(7): 1821-8). The present invention provides indirect supplementation of CLA in animal diets which may result in leaner meat and lower feed costs.

The composition of the present invention also may use highly insoluble modified forms of phospholipids, which contain a high percentage of unsaturated fatty acids. It is known that unsaturated fatty acids (UFA) have an adverse effect upon the rumen environment. Specifically, UFAs are toxic to microbes, particularly the cellulose digesters, reduce fiber digestion, coat the fiber particles, and lower rumen pH. Therefore, it is critical that the lecithin delivery matrix not hydrate readily in the rumen, thereby protecting the active agents and the UFAs from the ruminal microorganisms. The instant matrix however, will disintegrate and undergo digestion post-rumenally by the action of pancreatic lipases and other esterases, allowing the active agents to be digested in the intestine. Realization of the rumen bypass matrix is facilitated by the use of multivalent metal salts of PI, PE, and PA such as for example, calcium, aluminum, magnesium, iron, manganese, copper, and zinc. Such salts of said phospholipids have a very low hydration rate of ˜1%. (Brockisch M, Fats and Oils Handbook, AOCS, 1993; p.429). Methods for producing a multivalent metal complex of lecithin is well known to those in the art. Among the techniques that may be employed, U.S. Pat. No. 3,357,918 describes the use of divalent and trivalent metal ions to prepare liquid lecithin having a metal content up to 0.48% of Ca++. More particularly, the commercial production of a multivalent metal/lecithin complex is most easily prepared during the degumming of crude oil. As an example, soybean oil contains up to about 3% phosphatides. A metal salt solution, for example calcium chloride, is added to the crude oil, thereby hydrating the phosphatides and causing them to precipitate from the oil. After drying the precipitate, the resultant product is a metal salt of fatty acids (metal phosphate complexed lecithin) that is insoluble in water and therefore, not readily detected by the enzymes produced in the rumen. In addition, metal complexed lecithin is available from commercial suppliers such as, for example, Central Soya's Centromix E and CPS brands. However, these products are used in the manufacture of paints and not animal feed formulations. Small laboratory batches can be made by dissolving 1 gram of calcium chloride in 13 mL of ethyl alcohol. This solution is added to 44 mL of acetone, and the combination is mixed with 80 grams of 23% PC lecithin. The solvent is evaporated, leaving the dry calcium/lecithin complex.

Furthermore, the composition of the present invention may be made with lecithins that do not meet the specification for human consumption, or lecithins which remain in the sediment after ethanol extraction of PC from commercial lecithin. Such waste products contain higher amounts of the nonhydratable phospholipid fraction fractions PE and PI. (Cevc G et al, Phospholipids: Characterization, Metabolism, and Novel Biological Applications, AOCS. 1995; p. 353). More preferably, the lecithins contained in the MML/CP/CL are unbleached, and thus possess the advantages of having fewer functional groups, fewer oxidized fatty acids, less reaction with the salts, and a lower tendency to hydrate. The nonhydratable characteristics of the lecithin phospholipids allow them to pass more or less intact through the rumen into the intestine. The presence of phosphatidylcholine (a hydratable PL) in the PL mix functions to disintegrate the composition in the post-ruminal digestive tract where absorption takes place.

The active agents that may be used in the present invention include amino acids for example, lysine, methionine, histidine and tryptophane; hormones such as progesterone and growth hormones; minerals such as selenium, copper, zinc, manganese, cobalt, magnesium and chromium; macro-minerals, which include calcium, phosphorus, potassium, sodium, chlorine and sulfur; trace minerals, which include cobalt, copper, iodine, iron, manganese, selenium and zinc; antibiotics such as teramycin, tetracycline and bacitracin; and vitamins such as alpha tocopherol, tocotrienol, vitamins A, B, C and D; amino alcohols such as choline, ethanolamine and serine; polyols such as sorbitol, mannitol, and maltitol; emulsifiers such as monoglycerides, lactylates, diacetyltartaric acid esters, sugars, salts, phytochemicals, peptides, fats, enzymes, medicaments in general, and combinations thereof.

The active agents used in the present invention may be incorporated into the MML/CP/CL via the process of either cosolubilizing, or intimately mixing, or dispersing, or compounding depending upon the actives to be delivered to the ruminant. When subjected to pressure, shear, and heat for an adequate duration of time, it is believed the MML/CP/CL and the active agents coalesce into a new form, with their molecules binding to one another to create a continuous structure. Phospholipid compounds have health benefits beyond the nutrients that may be added to form the matrix. The phospholipids of the present invention are rich in vitamin E and unsaturated fatty acids. They also provide a source of choline, a major hepatic nutrient; serine, a repository for glucose in the liver and adipose tissues; and inositol, a fat metabolizer. Phospholipids also are antioxidants which exert a protective effect on unstable natural vitamins such as tocopherol alcohol.

Incorporating nutrients into the MML/CP/CL and thus forming the matrix may be accomplished for example, by direct compression in a bench press, or in an extruder, or in a three roll refiner, or in a dough mixer, or in chocolate mixing equipment. Whatever device is used, the MML/CP/CL and the nutrients must be subjected to a sufficient amount of pressure, preferably at least 100 psi, for an amount of time, preferably at least 5 seconds. Cosolubilization may also be accomplished by mixing or blending the active agents and MML with a solvent appropriately chosen to dissolve the ingredients. Subsequently the solvent is evaporated, leaving a dry mass. Thus, the original ingredients will have become a solid [liquid crystal] matrix. Regardless of whether the method used is one involving pressure or one involving a solvent, the resulting chemical composition will consist of a matrix containing the MML, active agents and other desirable excipients. At this point the active agents can only be separated from the MML by chemical means, such as with the use of solvents.

The solid matrix can be formed into a variety of sizes and shapes. At the very least it can be formed into particles which are between about 0.06 inches and 0.25 inches in diameter. The thickness is variable upwards from about 0.04 inches. The following are working examples demonstrating the production and use of the rumen protected nutrient-containing compositions.

### Example 1

Calcium modified lecithin (CML) was made from phospholipids and calcium chloride, so that the method of the present invention complexed the powdered phospholipids with the calcium having a pH of about 4.5. The CML composition was made by combining 482 grams of bleached lecithin Ultralec F (Archer Daniels Midland Co.) with 18 grams of 80% calcium chloride. These were mixed in the presence of 50 grams of deionized water, and the resultant powder was dried. The CaCl₂ used in this process represented 3.6% by weight of the total final composition. When 1 gram of the original unmodified lecithin was mixed with 14 grams of water, the pH of the solution was 4.8. After the lecithin was complexed with the calcium the solution pH was 4.5. The calcium complexed lecithin thus described, was used to produce a rumen protected matrix that contained the amino acid lysine. The matrix was made by mixing an amount of CML equal to 75% by weight of the total composition with an amount of lysine equal to 25% by weight of the total composition. Ten grams of this mixture was added to a die mounted on a bench hydraulic press. The die was made by Miller Tool Services, Winchester, Va. and had an internal diameter of 2.25 inches, an outside diameter of 3.825 inches, and a hole in the die face that was 0.25 inches in diameter. The hydraulic press was Carver Model C SPEX CertiPrep. After 5 grams of the lecithin/lysine mixture was added to the die, the die was closed, the hydraulic press was activated and 1500 psig was applied for approximately 2 minutes. During that time, the lecithin/lysine mixture exited the die in continuous strand of matrix that was 0.25 inches in diameter. The rumen protection afforded by the matrix described herein was measured in-vitro using an artificial rumen fermenter. The lecithin/lysine matrix was cut into pieces weighing between 0.2357-0.2369 grams. The weight of four samples of these cut pieces of lecithin/lysine matrix were measured after an incubation of 30 hours. The percentages of the original bleached lecithin/lysine matrix not digested after 30 hours were: 49.36%, 46.56%, 52.84%, 60.04%, and averaged 52.2%.

### Example 2

In order to determine the effects of aged CML, a matrix similar to that of Example 1 was prepared, except that the bleached CML was 15 months old. All conditions and processes such as the initial sample weight, ratio of lecithin to lysine, and incubation period were the same as Example 1. The percentages of the bleached lecithin/lysine matrix not digested after 30 hours were: 21.39%, 26.82%, 33.78%, 17.05%, and averaged 24.68%.

### Example 3

An amount of CML/lysine matrices of Examples 1 and 2 were tested further in the artificial rumen fermenter except that the 0.25 gram samples were crumbed instead of being in larger pieces. The percentages of CML/lysine matrix of Example 1 not digested after 12 hours were: 59.66%, 41.01%, 51.70% and averaged 50.79%. The percentages of CML/lysine matrix of Example 2 not digested after 12 hours were: 17.94%, 20.19%, 14.13% and averaged 17.42%. The rumen protection afforded by the matrix described herein is a function of the surface area exposed to the rumen fluid.

### Example 4

Calcium modified lecithin (CML) was made as in Example 1, except that 10 grams of 80% calcium chloride and 130 mL of ethyl alcohol were mixed at 70° C. with constant stirring until the CaCl₂ was dissolved. Acetone in the amount of 440 mL was added and the solution was cooled. 800 grams of bleached lecithin (ADM Ultralec F) was stirred into the solution, and the resultant mixture was dried. The CaCl2 used in this process represented 1.25% by weight of the total final composition. The calcium complexed lecithin thus described, was used to produce a rumen protected matrix that contained the amino acid lysine. The matrix was made by mixing an amount of CML equal to between 50% and 75% by weight of the total composition with an amount of lysine equal to between 25% and 50% by weight of the total composition. Ten grams of this mixture was compressed as in Example 1 and the resultant lecithin/lysine matrix was crumbed as in Example 3.

The rumen protection afforded by the matrices described herein was measured in-vitro using an artificial rumen fermenter. The weight of the samples were measured after an incubation of 6, 12, and 24 hours. The percentages of the bleached lecithin/lysine matrix not digested are given in Table 1.

TABLE 1
Percent of bleached CML/lysine matrices not digested

| % Lysine | 6 hours | 12 hours | 24 hours |
|---|---|---|---|
| 25.0 | 48.12 | 27.10 | 15.86 |
| 37.5 | 29.42 | 27.59 | 13.00 |
| 50.0 | 24.69 | 22.54 | 11.33 |

### Example 5

Calcium modified lecithin (CML) was made as in Example 4, except that an unbleached lecithin (Central Soya #01104110) was used in lieu of the aforementioned bleached lecithin. In vitro non-digested lecithin/lysine matrix weight measurements were taken as in Example 4, and the results are shown in Table 2.

TABLE 2
Percent of unbleached CML/lysine matrices not digested

| % Lysine | 6 hours | 12 hours | 24 hours |
|---|---|---|---|
| 25.0 | 54.85 | 34.00 | 25.41 |
| 37.5 | 40.27 | n/a | 22.17 |
| 50.0 | 28.61 | n/a | 13.83 |

### Example 6

A lecithin/lysine matrix was made as in Example 5 except that the amount of lysine incorporated was constant at 37.5% and a mixed fat (Megalac manufactured by Church & Dwight) was added prior to compression in an amount equal to 5% and 15% of the total final composition. In vitro non-digested lecithin/lysine matrix weight measurements were taken as in Example 4, and the results are shown in Table 3.

TABLE 3
Percent of unbleached CML/37.5% lysine/mixed
fat matrices not digested

| % Mixed Fat | 6 hours | 12 hours | 24 hours |
|---|---|---|---|
| 5.0 | 50.73 | 33.26 | 27.23 |
| 15.0 | 58.82 | 52.36 | 41.21 |

What is claimed is:

1. An composition comprising:
(i) a modified lecithin having the formula C₈H₁₇O₅NRR′, wherein R and R′ are fatty acids having the formula CH₃(CH₂)ₙCOO, wherein n is between 4 and 22; and
(ii) a active agent wherein said lecithin is present in an amount effective to protect said active agent from environmental oxidation.

2. The composition according to claim 1, wherein said active agent is intended for consumption by an animal that subjects said agent to ruminal fermentation degradation and said lecithin is present in an amount effective to protect said active agent from ruminal fermentation degradation while allowing for intestinal digestion and absorption of said active agent.

3. The composition of claim 1 wherein said lecithin phospholipid is non-hydratable whereby said lecithin phospholipids pass more or less intact through the rumen into the intestine.

4. The composition of claim 1, further comprising phosphatidylcholine in said lecithin composition in an amount effective to disintegrate said composition in the post-ruminal digestive tract.

5. The composition according to claim 1 wherein the amount of modified lecithin is between about 30% and 95% by weight of the total composition.

6. The composition according to claim 1 wherein the amount of active agents is between about 5% and 70% by weight of the total composition.

7. A method a providing an active agent to a ruminant comprising administering to said ruminant the composition of claim 1.

8. The composition of claim 1 wherein the lecithin is selected from the group consisting of bleached, unbleached, powdered, granular, liquid, coated, uncoated, and enriched.

9. The composition of claim 1 wherein the active agent is selected from the group consisting of: essential amino acids, vitamins, minerals, antibiotics, amino alcohols, polyols, peptides, phytochemicals, fats, rumen inert fats, fatty acid soaps, fatty acid salts, enzymes, emulsifiers, hormones, pharmaceuticals, disintegrants and other animal medicaments.

10. The composition of claim 9 wherein the essential amino acid is selected from lysine, methionine, histidine or combinations thereof.

11. The composition of claim 9 wherein the vitamins are selected from the group consisting of B-complexes, A, D, E, K, C, and combinations thereof.

12. The composition of claim 9 wherein the minerals are selected from the group consisting of cobalt, copper, iodine, iron, manganese, selenium, zinc or combinations thereof.

13. The composition of claim 9 wherein the antibiotics are selected from the group consisting of teramycin, tetracycline, bacitracin or combinations thereof.

14. The composition of claim 9 wherein the amino alcohols are selected from the group consisting of choline, ethanolamine, serine, or combinations thereof.

15. The composition of claim 9 wherein the polyols are selected from the group consisting of sorbitol, mannitol, maltitol or combinations thereof.

16. The composition of claim 9 wherein the emulsifiers are selected from the group consisting of monoglycerides, lactylates, diacetyltartaric acid esters, sugars, salts or combinations thereof.

17. The composition of claim 9 wherein the phytochemicals are selected from the group consisting of sterols, stanols, carotenoids, flavonoids or combinations thereof.

18. The composition of claim 9 wherein the fatty acid soaps are selected from the group consisting of calcium, magnesium, iron, zinc, chromium, manganese, copper fatty acid soaps or combinations thereof.

19. The composition of claim 9 wherein the rumen inert fats are selected from a group consisting of calcium salts of long chain fatty acids.

20. The composition of claim 19 wherein the rumen inert fat is further selected from the group consisting of Megalac, Super-Lac, Advance EB 100, EnerGII, Lipicafat, or combinations thereof.

21. A composition of claim 1 wherein the lecithin phospholipid carrier is complexed with a multivalent metal salt in a ratio of between 100:1 and 400:1.

22. The composition of claim 8 wherein the lecithin phospholipid carrier is complexed with a multivalent metal salt in a ratio of between 100:1 and 400:1.

23. The composition of claim 9 wherein the the lecithin phospholipid carrier is complexed with a multivalent metal salt in a ratio of between 100:1 and 400:1.

24. A method for making a composition which is rumen stable for providing active agents to ruminants, comprising: (i) selecting an amount of lecithin phospholipids or lecithin phospholipids complexed with a multivalent metal salt in a ratio of between 100:1 and 400:1, wherein said complexed amount is equal to between about 30% and about 95% by weight of the total composition, and (ii) selecting an amount of active agents in an amount equal to between about 5% and about 70% by weight of the total composition, and, (iii) mixing the said selected amounts of lecithin or complexed lecithin phospholipids and active agents in a mixing device, and (iv) placing an amount of the mixed lecithin phospholipids and active agents in a means for compressing said mixture, and (v) compressing and/or extruding said mixture in said compression means for at least 5 seconds at a pressure of at least 100 psig, whereby said compression means forms a matrix having a density range of between about 0.95 and 1.2.

25. The method of claim 24 wherein the lecithin phospholipid that is complexed with a multivalent metal salt is selected from unbleached, synthetic or coated lecithin.

26. The method of claim 24 wherein the lecithin phospholipid that is complexed with a multivalent metal salt is enriched phosphatidylcholine in excess of 23%, or phosphatidylethanolamine in excess of 21%, or phosphatidylinositol in excess of 19%.

27. The method of claim 24 wherein the active agents are selected from the group consisting of essential amino acids, vitamins, minerals, antibiotics, amino alcohols, polyols, peptides, phytochemicals, fats, rumen inert fats, fatty acid soaps, fatty acid salts, enzymes, emulsifiers, hormones, pharmaceuticals, disintegrants and other animal medicaments.

28. The method of claim 24 wherein an additives may be added to the complexed lecithin phospholipid and active agents, in the compression means to alter the bioavailability of the active agents.

29. The method of claim 24 wherein the additives are selected from the group consisting of disintegrants, calcium stearoyl-2-lactylate, sodium stearoyl lactylate, ethoxylated monoglyceride, polysorbates, dry monoglycerides, starches and sugars.

30. The method of claim 28 wherein the additive is modified lecithin phospholipids.

31. The method of claim 30 wherein the modified lecithin phospholipids are further selected from the group consisting of hydroxylated lecithin, and enzyme modified lecithin.

32. The method of claim 24 further comprising the forming of the rumen stable composition into a size and shape suitable for ingestion by ruminant animals.
